(19) United States
(12) Patent Application Publication
(10) Pub. No.: US 2002/0022160 A1
(43) Pub. Date: Feb. 21, 2002

(54) Novel compositions for use as electrode materials and for hydrogen production

(76) Inventor: David G. Schmidt, Dahlonega, GA (US)

Correspondence Address: John K. McDonald, Ph.D., KILPATRICK STOCKTON LLP, 2400 Monarch Tower, 3424 Peachtree Road, N.E., Atlanta, GA, 30326, US

(21) Appl. No.: 09/886,935

(22) Filed: Jun. 21, 2001

Related U.S. Application Data
(60) Provisional application No. 60/213,945, filed on Jun. 23, 2000.

(51) Int. Cl. H01M 4/38; H01M 4/36; H01M 4/40; C01B 3/08; H01M 8/06; H01G 9/042

(52) U.S. Cl. 429/5; 429/232; 429/226; 429/223; 429/218.1; 429/19; 423/657; 361/528

(57) ABSTRACT

This invention provides new compositions, methods for making these compositions, and methods of using the compositions in a variety of energy-related applications. These compositions are useful as electrode materials in devices such as batteries, capacitors, fuel cells and similar devices as also in the direct production of hydrogen and oxygen gas. The new compositions of the present invention comprise: (A) one or more of the transition metal elements; optionally (B) aluminum; optionally (C) one or more of the group 1A alkali metal elements; (D) one or more elements and/or compounds having high mobility values for electrons; and (E) a source of ionizing radiation. Thus, components A, D and E are required ingredients of the present invention, and components B and C are both optional. Components B and C may be used independently alone, together, or not at all.

### PRIOR RELATED U.S. APPLICATION DATA

This application claims priority to U.S. provisional application serial No. 60/213,945, filed Jun. 23, 2000.

### TECHNICAL FIELD OF THE INVENTION

The present invention provides new compositions, methods for making these compositions, and methods of using these compositions as electrode materials in a range of applications, including batteries, capacitors, fuel cells and similar devices. The novel compositions of the present invention may also be used to generate hydrogen and oxygen gas.

### BACKGROUND OF THE INVENTION

Advanced materials, including new compositions, are used in enhancing the performance of batteries, capacitors, fuel cells, and similar devices. One principal application of new compositions is in electrode materials, therefore advancements in energy production have paralleled developments in performance of new materials. Electrodes may function in many ways, and numerous electrode materials are typically available for specific applications. For example, primary batteries often use electrodes comprising zinc as a principal component. In this case, the zinc electrode serves as a source of electrons, but once all the zinc has been oxidized, the primary battery is exhausted. Therefore, any primary battery system stops working and must be discarded after one of its chemicals has been depleted. The total amount of energy produced by this type of primary battery system depends upon how much active material is contained within the battery.

Capacitors are devices that store electrical energy and then rapidly discharge that energy when required. Electrode materials play a key role in capacitor performance. For example, the aluminum electrolytic capacitor, as disclosed in U.S. Pat. No. 5,448,448, represents a typical electrolytic capacitor. Great emphasis is placed on the voltage rating of the capacitor as well as its ability to store electrons (rated in Farads). In certain applications, there would be great advantage for the capacitor to be able to both rapidly generate and also discharge energy. The majority of capacitors found in the prior art do not possess both of these attributes.

Another type of electrode is used in fuel cells. A fuel cell operates as a galvanic cell wherein one of the reactants is a fuel, such as hydrogen or methane. One such fuel cell system is disclosed in U.S. Pat. No. 5,962,155. Fuel cells may operate using platinum electrodes or porous carbon electrodes containing metal catalysts. In contrast to the electrodes of a primary battery, fuel cell electrodes are not the source of electrons but serve primarily to interact with the fuel and to shuttle electrons through the cell. A fuel cell reactant is not contained within the cell, but must be continuously supplied from an external source. Although fuel cells show great promise as a replacement to some portable energy sources, the cost and the problems associated with the storage and delivery of fuels such as hydrogen have prohibited their widespread use.

An associated problem in energy technology, especially related to fuel cell operation, is that of generating and storing hydrogen gas. The use of hydrogen gas as a fuel is environmentally advantageous, because hydrogen burns in the presence of oxygen to yield water as a by-product. The dominant industrial process for producing hydrogen is the catalytic steam-hydrocarbon reforming process using natural gas (largely methane) or oil-refinery feedstocks at high temperatures (e.g. 900° C.). Hydrogen gas is stored in compressed gas cylinders for transport and use elsewhere. On a smaller scale, hydrogen gas may be produced by the well-known electrolysis method, but energy must be supplied from other sources for this process. The reaction of acid with many metals produces hydrogen gas, but this method is more useful in small scale applications and is not economically feasible. Another means for generating hydrogen gas is to store the hydrogen in the form of a metal hydride. While this technology stores hydrogen more safely than in compressed gas tanks, after the hydrogen is consumed, the metal hydride must again be recharged with hydrogen gas.

What is needed are new and better ways to generate hydrogen. What is further needed are new ways to store and utilize hydrogen safely for energy production in remote locations where it may be used for combustion, fuel cell operation, or other energy applications. What is also needed are new and better compositions for use as electrodes that exceed the performance capabilities of those currently used in devices such as batteries, capacitors, and fuel cells. What is also needed is a hybrid electrode that could serve more than one energy production function, such as a hybrid fuel cell using electrodes for both hydrogen production and electron transfer functions.

### SUMMARY OF THE INVENTION

The present invention provides new compositions, methods for making these compositions, and methods of using these compositions in a wide variety of applications. All of the compositions of the present invention may be used for electrode materials in batteries, capacitors, fuel cells, and the like, as well as for the production of hydrogen gas.

The new compositions of the present invention comprise: (A) one or more of the transition metal elements; optionally (B) aluminum; optionally (C) one or more of the group 1A alkali metal elements; (D) one or more elements and/or compounds having high mobility values for electrons; and (E) a source of ionizing radiation. Thus, components A, D and E are required ingredients of the present invention, and components B and C are both optional. Components B and C may be used together, alone, or not at all.

As a consequence of the optional components B and C, there are four types of compositions of the present invention, and each type of composition may be used for any of the applications described herein. Thus, any one of these compositions of the present invention are useful for the production of hydrogen gas and for electrode materials.

One type of composition of the present invention comprises all of the components A, B, C, D and E recited immediately above. Therefore, this type of composition comprises: (A) one or more of the transition metal elements; (B) aluminum; (C) one or more of the group 1A alkali metal elements; (D) one or more elements and/or compounds having high mobility values for electrons; and (E) a source of ionizing radiation.

Another type of composition of the present invention comprises components A, B, D and E recited above. Thus, this type of composition comprises: (A) one or more of the transition metal elements; (B) aluminum; (D) one or more elements and/or compounds having high mobility values for electrons; and (E) a source of ionizing radiation.

Yet another type of composition of the present invention comprises components A, C, D and E recited above. Therefore, this type of composition comprises: (A) one or more of the transition metal elements; (C) one or more of the group 1A alkali metal elements; (D) one or more elements and/or compounds having high mobility values for electrons; and (E) a source of ionizing radiation.

One other type of composition of the present invention comprises components A, D and E recited immediately above. Thus, this type of composition comprises: (A) one or more of the transition metal elements; (D) one or more elements and/or compounds having high mobility values for electrons; and (E) a source of ionizing radiation.

Component A of the present invention comprises one or more transition metals, that is, metals of the groups 1B, 2B, 3B, 4B, 5B, 6B, 7B, and 8B metals of the periodic table. Preferably, the composition of the present invention comprises one or more of the group 8B transition metals iron, ruthenium, osmium, cobalt, rhodium, iridium, nickel, palladium or platinum. More preferably, the composition of the present invention comprises of one or more of nickel, palladium or platinum. More preferably still, the composition of the present invention comprises nickel. Nickel is preferred for several reasons, including its high catalytic activity and its relative cost as compared with other transition metals.

Components B and C comprise (B) aluminum and (C) one or more of the group 1A alkali metal elements, respectively. Both these components are optional in the compositions of the present invention. Thus, components B and C may each be present independently, in combination, or both may be absent from the compositions of the present invention. The group 1A alkali metal elements comprise Li, Na, K, Rb, Cs, and Fr. When present alone or together, components B and C are typically processed together with the other components A and D to form the alloy compositions of the present invention. Moreover, when component E is a material such as a radioactive metal, it may also be incorporated into the composition as a component of the alloy, or it may be placed in contact with an alloy of the other components.

Component D of the present invention comprises one or more elements and/or compounds having high mobility values for electrons, that is, semiconductor materials. These elements and/or compounds are characterized by an electron mobility value from about 100 cm²/V.s to about 100,000 cm²/V.s. Regardless of the intended utility of the composition of the present invention, component D is included as a composition component and is therefore processed together with the other composition components A, optionally B, optionally C, and in some embodiments E, to form compositions of the present invention.

Component E of the present invention comprises a source of ionizing radiation, that is, either a material or a device capable of emitting ionizing radiation. When component E is a material such as a radioactive metal, it may be incorporated into the composition as a component of the alloy and processed accordingly. However, it is not necessary that component E be melted along with the other components to form an alloy, because the radioactive material may alternatively constitute a separate component such as a rod, foil, sheet, and so forth, which is placed into contact with the composition comprising the other components A, optionally B, optionally C, and D. In one embodiment, component E comprises thorium metal which is placed into contact with the composition of the other components. In another embodiment, component E is a device that emits ionizing radiation and is physically configured so as to irradiate, and induce ionization in, the composition.

An examination of the metallurgical phase diagrams for various composition components of this invention, for example, aluminum (B) and some high electron mobility components (D), reveal limited solubilities in each other. As a result, it is expected that large macrosegregation domains result from attempts to form alloys of these components in the specified percentages. Therefore, the present invention also provides a method of manufacturing alloys that reduces macrosegregation and improves homogeneity in an otherwise nonhomogeneous sample.

The compositions of the present invention are typically prepared by combining and melting at least some of the components of the composition in a standard arc melting furnace, induction furnace, vapor deposition chamber, or sintering furnace, in ways known to one of ordinary skill in the art, to form alloys. Typically, components A, optional components B and C, and component D are processed into alloys by melting when used in the composition of the present invention. When component E is a material that can be melted, such as a radioactive metal, it may be incorporated into the alloy along with the other components and processed accordingly. However, it is not necessary that component E be incorporated with the other components to form an alloy, because E may simply be placed into contact with the alloy of the other components.

In some embodiments of this invention, it is desirable to form intermediate or pre-melt alloys comprising a subset of the composition components, and subsequently use the intermediate alloy composition(s) in a melting step together with the remaining alloy components. Typically, sufficient physical agitation accompanies the arc melting process to provide the preferred high sample homogeneity. While some physical agitation accompanies the induction melting process, it may or may not be necessary to apply additional physical agitation and/or sonication treatments to the melted sample to achieve the preferred high sample homogeneity. These treatments are made during the cooling step while the pre-melt alloy or final melt composition sample is still in the liquid state.

The compositions of the present invention are especially useful for the production of hydrogen and oxygen gas. For all the compositions of the present invention, it is only necessary to contact the composition with water to produce hydrogen and oxygen. However, the preferred method of using a particular composition for this purpose depends upon the components of the composition. For example, in compositions that contain aluminum but do not contain a group 1A alkali metal, one preferred method of producing hydrogen gas is to contact the composition with aqueous base. The aqueous base is typically an aqueous metal hydroxide solution, though other soluble bases may be used. Hydroxide compounds often selected to fulfill this role, include but are not limited to LiOH, NaOH, KOH, RbOH, CsOH, Mg(OH)₂, Ca(OH)₂, Sr(OH)₂, and Ba(OH)₂. Basic compounds other than hydroxides are also useful in the present invention, such as aqueous solutions of Na₂CO₃, K₂CO₃, CaO or NH₃. Each of these compounds forms hydroxide ion when placed in contact with water.

In the typical reaction between an alkali metal and water, hydrogen and heat energy are liberated very rapidly, sometimes explosively, because the hydrogen formed may ignite as it is generated. In contrast, the alloy compositions of the present invention, even those that contain at least one alkali metal, release hydrogen and energy over a period of a few hours to a few weeks when contacted with water. Thus, the compositions overcome prior art limitations of producing hydrogen from alkali metal and water by sustaining and extending the release of hydrogen gas in a more controlled fashion. This feature also provides several advantages over other prior art methods for producing hydrogen. First, electricity is not needed to generate the hydrogen as in known electrolysis systems. Second, hydrogen gas is generated on demand when needed and not stored under high pressure in compressed gas tanks. Third, the compositions of the present invention liberate hydrogen gas more efficiently than conventional metal hydride storage systems. These compositions may be used in applications where it is desirable for the composition to react only with water, or with water containing other materials such as salts or contaminants.

Once generated, hydrogen gas may be used in various applications including, but not limited to, internal combustion engines, heating, ion propulsion, magnetohydrodynamics (MHD), fuel cells, welding, hydrogenation of oils, hydrogenation of petroleum and petrochemical fuels, hydrogenation of polymer related materials, reduction of organic compounds, reduction of inorganic and organometallic compounds, hydrogenation of volatile materials in vapor deposition processes, conventional jet propulsion, rocket fuel, and other applications.

The compositions of the present invention have a range of potential uses as electrode materials in a number of energy production and storage devices. Thus, the compositions are useful as components of batteries, capacitors, fuel cells, hybrid battery/fuel cell designs, and the like. When used as an electrode material in primary batteries, the compositions of the present invention address the limitations of prior art technologies by providing a battery with improved energy density compared to conventional primary battery systems.

The compositions of the present invention are useful as electrode materials in a capacitor device. The present invention overcomes the limitations of prior art technologies by allowing the capacitor to both store and generate electrical energy, unlike conventional capacitors which can only store energy. This improvement provides a capacitor with a greater energy density and more potential applications than currently available with conventional capacitor systems.

The compositions of the present invention are useful as electrode materials in a hybrid fuel cell device. The present invention overcomes the limitations of prior art technologies by allowing the composition material to serve as both electrode and fuel source for the fuel cell device. This feature circumvents the need to provide hydrogen fuel separately, and has the advantage of using the fuel cell electrolyte as an electron transport medium. Such a fuel cell has a greater energy density and more potential applications than available with conventional fuel cell systems. Moreover, the compositions of the present invention are considerably less expensive than the platinum or platinum alloy electrodes of conventional hydrogen fuel cells.

In addition to the utility of the compositions in a fuel cell design described above, wherein the compositions serve as both an electrode material and fuel source, the compositions of the present invention also serve as a fuel source for a conventional fuel cell. Because hydrogen is generated on demand, an advantage is gained over fuel cells that store hydrogen in compressed gas tanks or other means.

Accordingly, it is an object of the present invention to provide novel compositions.

It is an object of the present invention to provide compositions comprising: (A) one or more of the transition metal elements; optionally (B) aluminum; optionally (C) one or more of the group 1A alkali metal elements; (D) one or more elements and/or compounds having high mobility values for electrons; and (E) a source of ionizing radiation.

It is an another object of the present invention to provide compositions comprising: (A) one or more of the transition metal elements; (B) aluminum; (C) one or more of the group 1A alkali metal elements; (D) one or more elements and/or compounds having high mobility values for electrons; and (E) a source of ionizing radiation. This type composition comprises all of the components A through E recited above.

It is yet another object of the present invention to provide compositions comprising: (A) one or more of the transition metal elements; (B) aluminum; (D) one or more elements and/or compounds having high mobility values for electrons; and (E) a source of ionizing radiation.

Yet another object of the present invention is to provide compositions comprising: (A) one or more of the transition metal elements; (C) one or more of the group 1A alkali metal elements; (D) one or more elements and/or compounds having high mobility values for electrons; and (E) a source of ionizing radiation.

It is a further object of the present invention to provide compositions comprising: (A) one or more of the transition metal elements; (D) one or more elements and/or compounds having high mobility values for electrons; and (E) a source of ionizing radiation.

It is another object of the present invention to provide methods of making the novel compositions of the present invention.

Yet a further object of the present invention is to provide suitable methods of manufacturing the compositions of the present invention, including but not limited to, arc melting, induction melting, physical vapor deposition, chemical vapor deposition, and sintering.

A further object of the present invention is to provide compositions useful as electrode materials.

Another object of the present invention is to provide compositions useful as electrode materials in devices such as batteries, capacitors, fuel cells and similar devices.

A further object of the present invention is to provide compositions that generate hydrogen gas.

Yet another object of the present invention is to provide compositions that produce hydrogen gas upon contact with water or aqueous base, thereby providing compositions that may be used in numerous applications requiring hydrogen gas. These applications include, but are not limited to, in internal combustion engines, heating, ion propulsion, magnetohydrodynamics (MHD), fuel cells, welding, hydrogenation of oils, hydrogenation of petroleum and petrochemical fuels, hydrogenation of polymer related materials, reduction of organic compounds, reduction of inorganic and organometallic compounds, hydrogenation of volatile materials in vapor deposition processes, conventional jet propulsion, rocket fuel, and other applications.

Another object of the present invention is to provide compositions useful in a hybrid battery system.

Another object of the present invention is to provide compositions useful as a fuel source in a fuel cell.

Yet another object of the present invention is to provide compositions useful in a hybrid battery/fuel cell system where the compositions serve as both electrode and fuel source for the fuel cell device.

It is a further object of the present invention to provide a method of producing hydrogen that does not require the use of electricity.

Yet another object of the present invention is to provide a method of hydrogen production in which hydrogen gas is generated on demand when needed and is not stored under high pressure in compressed gas tanks.

These and other objects, features and advantages of the present invention will become apparent after a review of the following detailed description of some of the disclosed embodiments.

### BRIEF DESCRIPTION OF THE DRAWING

FIG. 1 illustrates the gas production from one embodiment of the present invention, namely the composition described in Example 3 (labeled B), as compared to the gas production from the alloy of Example 3 when thorium is absent (labeled A).

### DETAILED DESCRIPTION OF THE PRESENT INVENTION

The present invention provides novel compositions, methods of making the compositions and methods of using the compositions in a wide range of applications. The new compositions of the present invention comprise: (A) one or more of the transition metal elements; optionally (B) aluminum; optionally (C) one or more of the group 1A alkali metal elements; (D) one or more elements and/or compounds having high mobility values for electrons; and (E) a source of ionizing radiation. Thus, components A, D and E are required ingredients of the present invention, and components B and C are both optional. Components B and C may be used independently alone, together, or not at all. Numerous applications for these compositions are disclosed, such as uses in electrode materials and for the production of hydrogen and oxygen gas, and any of the compositions of the present invention may be used in any of these applications.

There are generally four types of compositions of the present invention, and each type of composition may be used for any of the applications described herein.

One type of composition of the present invention comprises all of the components A, B, C, D and E recited immediately above. Therefore, this type of composition comprises: (A) one or more of the transition metal elements; (B) aluminum; (C) one or more of the group 1A alkali metal elements; (D) one or more elements and/or compounds having high mobility values for electrons; and (E) a source of ionizing radiation.

Another type of composition of the present invention comprises components A, B, D and E recited above. Therefore, this type of composition comprises: (A) one or more of the transition metal elements; (B) aluminum; (D) one or more elements and/or compounds having high mobility values for electrons; and (E) a source of ionizing radiation.

Yet another type of composition of the present invention comprises components A, C, D and E recited above. Thus, this type of composition comprises: (A) one or more of the transition metal elements; (C) one or more of the group 1A alkali metal elements; (D) one or more elements and/or compounds having high mobility values for electrons; and (E) a source of ionizing radiation.

A further type of composition of the present invention comprises components A, D and E recited immediately above. Thus, this type of composition comprises: (A) one or more of the transition metal elements; (D) one or more elements and/or compounds having high mobility values for electrons; and (E) a source of ionizing radiation.

These compositions are also designed to release hydrogen and oxygen gas in a controlled and useful fashion upon contacting the compositions with water. It is only necessary to contact the composition with water to produce hydrogen and oxygen, although the preferred method of using a particular composition for this purpose depends upon the components in that composition. Thus, these compositions may be used in many of the well-established applications for hydrogen gas

The compositions of the present invention may also serve as both an electrode and a fuel source, and be used in hybrid fuel cells. The compositions of the present invention may also be used in a new capacitor which both stores and generates electrical energy. The present compositions are also useful as anode materials in a number of applications, such as in batteries, fuel cells, capacitors, and hybrid battery/fuel cell designs.

### Definitions

In order to more clearly define the various terms as used herein, the following definitions are provided.

The term “composition” as used herein to means the composition as defined by the components described below. Thus, compositions of the present invention comprise at least the following components: (A) one or more of the transition metal elements; (D) one or more elements and/or compounds having high mobility values for electrons; and (E) a source of ionizing radiation. The compositions may also comprise the optional components (B) aluminum and/or (C) one or more of the group 1A alkali metal elements. Thus, “composition” refers to the combination of components as specified above, regardless of whether some or all of these components are processed by melting into alloys.

The term “alloy” refers to the mixture of components, or the subset of components, of the present invention that are processed by the melting, deposition or sintering techniques described herein. Thus, “alloy” may be synonymous with “composition” when all of the components are processed together. For example, when component E is a material such as a radioactive metal that is amenable to melting and incorporation into an alloy, the alloy constitutes the composition of the present invention. However it is not necessary that component E be melted along with the other components to form the alloy, because E may constitute a separate constituent such as a rod, foil, sheet, and so forth, which is simply placed into contact with the alloy comprising the other components A, optionally B, optionally C, and D. In this latter embodiment, component E is a necessary component of the “composition” of the present invention, but is not a required component of the “alloy” as used herein.

The term “transition metal” and such variations as “transition metal element” and “transition element,” as used herein, refer to the metals in groups 1B, 2B, 3B, 4B, 5B, 6B, 7B, and 8B, of the periodic table of elements, referring specifically to the elements scandium, yttrium, lanthanum, actinium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. These elements are also described in the present application by their common one or two letter abbreviations known to one of ordinary skill in the art.

The terms “group 8B metal”, “8B metal”, or simply “group 8 metal” as used herein, refer to the metals iron, ruthenium, osmium, cobalt, rhodium, iridium, nickel, palladium, and platinum.

The terms “group 1A alkali metal” and such variations as “group 1A metal” and simply “alkali metal,” as used herein, refer to the metals in group 1A of the periodic table, namely Li, Na, K, Rb, Cs, and Fr.

The term “high electron mobility” element, compound, material, or component, and such variations as materials “having high mobility values for electrons” or “semiconductors,” as used herein, refer to species characterized by an electron mobility value from about 100 cm²/V.s to about 100,000 cm²/V.s. Examples of these species, which typically comprise semiconductor materials, include, but are not limited to C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃, and Te.

The term “ionizing radiation” and related terms such as “radiation”, as used herein, includes α-, β-, γ-, and X-radiation, from any source. Thus, the source of ionizing radiation can be a material or a device capable of emitting ionizing radiation. Suitable materials include radioactive elements, that can either be placed in contact with the alloy components A, optionally B, optionally C, and D, or can be melted as an alloy component itself. Other suitable materials include radioactive compounds that can be placed in contact with the alloy components in some fashion. Materials suitable for use as component E of the present invention include, but are not limited to, isotopes of thorium, uranium, ruthenium, cesium, krypton, radium, strontium, and tritium.

### Compositions of the Present Invention

The compositions of the present invention are described by their components and the weight percentages of each component. It is to be understood that these recited percentages are percents by weight of each component with respect to the weight of a final composition assumed to contain only these cited components. Thus, while additional components may be added to the alloys of the present invention, the stated weight percentages are relative to the portion of the final composition containing only these components. It is to be understood that the inclusion of additional ingredients is encompassed within the present invention, depending upon the application for which a particular composition is intended, provided the additional ingredients do not adversely affect the function of the composition. It is also to be understood that the weight percentages recited herein include weights that are about 10% above or below the actual weight represented by that percentage.

In general terms, the compositions of the present invention comprise the following components: (A) one or more of the transition metal elements; optionally (B) aluminum; optionally (C) one or more of the group 1A alkali metal elements; (D) one or more elements and/or compounds having high mobility values for electrons; and (E) a source of ionizing radiation. The source of ionizing radiation, component E, is typically a radioactive metal that is either part of an alloy comprising the other composition components, or placed in contact with the other components A, D, and optionally B and/or C.

It has been observed that hydrogen and oxygen gas are generated when components A, D and E are placed in contact with water, even in the absence of aluminum and alkali metal. It has also been observed that when component E is a radioactive metal and is in contact with the alloys comprising the other components A, B, C, and D, more hydrogen gas is produced from the alloy, and over a longer period of time, than in the absence of the radioactive material, under similar experimental conditions.

In all the embodiments described herein, percentages are expressed by weight, unless otherwise specified. In general, the one or more transition metals of the present invention are present in about 1% to about 80% of the composition by weight. When present, the aluminum is incorporated in an amount from about 2% to about 95% by weight of the composition. The one or more of the group 1A alkali metals are present in an amount from about 1% to about 90% by weight of the composition, when present. The one or more elements and/or compounds having high mobility values for electrons component are present in the composition in an amount from about 3% to about 82% by weight. The material that emits ionizing radiation is present from about 2% to about 90% of the composition, whether this component is melted and processed along with the other components, or simply placed in contact with the alloy comprising the other components. The amount of each component used in an embodiment of the alloy depends on, among other things, the anticipated use of that alloy. Guidelines for determining the amount of each component are provided herein.

In one embodiment of the present invention, wherein the composition comprises components A, B, C, D and E recited above, the approximate weight percentages of the components are: (A) about 60% nickel; (B) about 20% aluminum; (C) about 10% lithium; and (D) about 10% germanium which are processed into an alloy. The composition further comprises (E) a thorium-containing metal rod (about 2% thorium in tungsten) placed in contact with an alloy monolith comprising components A, B, C and D, and weighing about the same as the alloy sample. Alternatively, in another embodiment, thorium foil can be wrapped around the outside of the A, B, C and D alloy.

In another embodiment of this invention, wherein the composition comprises A, B, C, D and E recited above, the approximate weight percentages of the components are: (A) about 6% nickel; (B) about 20% aluminum; (C) about 10% lithium; and (D) about 29.1% indium, about 30.9% antimony, and about 4% germanium, which are processed into an alloy. The composition further comprises (E) a thorium-containing metal rod (about 2% thorium in tungsten) placed in contact with an alloy monolith comprising components A, B, C and D, and weighing about the same as the alloy sample.

In another embodiment of this invention, wherein the composition comprises A, B, C, D and E recited above, the approximate weight percentages of the components are: (A) about 10% nickel; (B) about 20% aluminum; (C) about 10% lithium; and (D) about 29.1% indium, and about 30.9% antimony which are processed into an alloy. The composition further comprises (E) a thorium-containing metal rod (about 2% thorium in tungsten) placed in contact with an alloy monolith comprising components A, B, C and D, and weighing about the same as the alloy sample. Alternatively, the composition may comprise components A, B, C and D recited above, and (E) a thorium foil placed in contact with an alloy monolith comprising components A, B, C and D.

In another embodiment of this invention, wherein the composition comprises A, B, C, D and E recited above, the approximate weight percentages of the components are: (A) about 6.7% nickel and about 8.5% palladium; (B) about 3% aluminum; (C) about 1.5% lithium; and (D) about 18.8% indium, about 20% antimony, about 3.5% germanium, and about 38% tin, which are processed into an alloy. The composition further comprises (E) a thorium-containing metal rod (about 2% thorium in tungsten) placed in contact with an alloy monolith comprising components A, B, C and D, and weighing about the same as the alloy sample.

In another embodiment of this invention, wherein the composition comprises A, B, C, D and E recited above, the approximate weight percentages of the components are: (A) about 6.7% nickel; (B) about 26.65% aluminum; (C) about 25.15% sodium; and (D) about 3.5% germanium and about 38% tin, which are processed into an alloy. The composition further comprises (E) a thorium-containing metal rod (about 2% thorium in tungsten) placed in contact with an alloy monolith comprising components A, B, C and D, and weighing about the same as the alloy sample.

In yet another embodiment of this invention, wherein the composition comprises A, B, C, D and E recited above, the approximate weight percentages of the components are: (A) about 5.00% nickel; (B) about 24.28% aluminum; (C) about 62.07% sodium; and (D) about 8.65% indium antimonide, which are processed into an alloy. The composition further comprises (E) a thorium-containing metal rod (about 2% thorium in tungsten) placed in contact with an alloy monolith comprising components A, B, C and D, and weighing about the same as the alloy sample.

In another embodiment of this invention, wherein the composition comprises A, B, C, D and E recited above, the approximate weight percentages of the alloy components are: (A) about 5.00% nickel; (B) about 48.56% aluminum; (C) about 41.38% sodium; and (D) about 5.06% indium antimonide, which are processed into an alloy. The composition further comprises (E) a thorium-containing metal rod (about 2% thorium in tungsten) placed in contact with an alloy monolith comprising components A, B, C and D, and weighing about the same as the alloy sample.

In still another embodiment of this invention, wherein the composition comprises A, B, C, D and E recited above, the approximate weight percentages of the components are: (A) either about 2.5% nickel, about 2.5% palladium or about 2.5% platinum; (B) about 24.28% aluminum; (C) about 62.07% sodium; and (D) about 8.65% indium antimonide, which are processed into an alloy. The composition further comprises (E) a thorium-containing metal rod (about 2% thorium in tungsten) placed in contact with an alloy monolith comprising components A, B, C and D, and weighing about the same as the alloy sample.

In yet another embodiment of this invention, wherein the composition comprises A, B, C, D and E recited above, the approximate weight percentages of the components are: (A) either about 2.5% nickel, about 2.5% palladium or about 2.5% platinum; (B) about 48.56% aluminum; (C) about 41.38% sodium; and (D) about 5.06% indium antimonide, which are processed into an alloy. The composition further comprises (E) a thorium-containing metal rod (about 2% thorium in tungsten) placed in contact with an alloy monolith comprising components A, B, C and D, and weighing about the same as the alloy sample.

In still another embodiment of this invention, wherein the composition comprises A, B, D and E recited above, the approximate weight percentages of the components are: (A) about 5% nickel; (B) about 90% aluminum; and (D) about 5% germanium, which are processed into an alloy. The composition further comprises (E) a thorium-containing metal rod (about 2% thorium in tungsten) placed in contact with an alloy monolith comprising components A, B, and D, and weighing about the same as the alloy sample.

In yet another embodiment of this invention, wherein the composition comprises A, C, D and E recited above, the approximate weight percentages of the components are: (A) about 5% nickel; (C) about 90% lithium; and (D) about 5% indium antimonide, which are processed into an alloy. The composition further comprises (E) a thorium-containing metal rod (about 2% thorium in tungsten) placed in contact with an alloy monolith comprising components A, C and D, and weighing about the same as the alloy sample.

In another embodiment of this invention, wherein the composition comprises A, D and E recited above, the approximate weight percentages of the alloy components are: (A) about 90% nickel; and (D) about 10% germanium or about 10% indium antimonide, which are processed into an alloy. The composition further comprises (E) a thorium-containing metal rod (about 2% thorium in tungsten) placed in contact with an alloy monolith comprising components A and D, and weighing about the same as the alloy sample.

The alloys of the present invention are prepared by combining and melting the alloy components in a standard arc melting furnace, induction furnace, vapor deposition chamber, or sintering furnace using techniques known to one of ordinary skill in the art. In some embodiments of this invention, it is desirable to form intermediate or premelt alloys comprising a subset of the alloy components, and subsequently use the intermediate alloy(s) in a melting step along with the remaining alloy components. Typically, sufficient physical agitation accompanies the arc melting process to afford the preferred high sample homogeneity. While some physical agitation accompanies the induction melting process, it may or may not be necessary to apply additional physical agitation and/or sonication treatments to the melted sample to achieve the preferred high sample homogeneity. These treatments are made during the cooling step while the pre-melt alloy or final melt alloy sample is still in the liquid state.

In order to produce hydrogen and oxygen gas from the compositions of the present invention, the compositions are contacted with either water or aqueous hydroxide ion. While all of the compositions of the present invention produce hydrogen and oxygen gas upon contact with water, the preferred method of using a composition for this purpose depends upon the components of that particular composition. For example, in compositions that contain aluminum but do not contain a group 1A alkali metal, a preferred method of producing hydrogen and oxygen gas is to contact the composition with aqueous base. The aqueous base used for reaction with aluminum containing alloys is typically an aqueous metal hydroxide solution such as KOH, though other bases may be used. Soluble hydroxide compounds often selected to fulfill this role, including but not limited to LiOH, NaOH, KOH, RbOH, CsOH, Mg(OH)₂, Ca(OH)₂, Sr(OH)₂, and Ba(OH)₂. Basic compounds other than hydroxides are also useful in the present invention, such as aqueous solutions of Na₂CO₃, K₂CO₃, CaO or NH₃. Each of these compounds forms hydroxide ion when placed in contact with water. The compositions of the present invention release hydrogen and oxygen over a period of a few hours to a few weeks when reacted with water or aqueous base in this fashion.

When optional components B and/or C are present in the composition, the initial rate of hydrogen gas production is greater than when the composition contains only components A, D and E. Thus, the reaction of an alkali metal with water to form hydrogen is well known, therefore, if an alkali metal is present in the composition, with or without aluminum, it is only necessary to contact the composition with water to produce hydrogen. It is also known that aluminum reacts with aqueous base under various conditions to form hydrogen, therefore, any aluminum-containing composition can be contacted with aqueous base (hydroxide ion) to produce hydrogen. In addition to hydrogen, the by-product of the reaction between alkali metals and water is aqueous alkali metal hydroxide. Therefore if both alkali metal and aluminum are present in a composition, this aqueous base by-product will serve as a reactant for producing hydrogen from aluminum. Therefore, it is believed that when an alloy of the present invention contains both aluminum and at least one group 1A alkali metal, hydrogen production may arise from reactions of both these components with water—and the resulting hydroxide ion—in addition to hydrogen produced from the interaction of components A, D and E with water.

When the compositions of the present invention are employed in batteries, capacitors, and similar devices, they are typically used in conjunction with an electrolyte, which is required for forming a conductive solution. Aqueous base is a useful electrolyte in the present invention. However, soluble salts such as RbNO₃ and NaNO₃, which constitute neutral salts, in addition to soluble basic salts, such as NaOH, KOH, or K₂CO₃ are useful in the present invention In these latter cases, hydrogen is produced as a byproduct of the battery or capacitor function.

Examples compounds that form electrolyte solutions also include, but are not limited to, the lithium, sodium, potassium, rubidium and/or cesium compounds or salts of the following anions: acetate, bicarbonate, bisulfate, bromide, carbonate, chlorate, chloride, chloroplatinate, chloroplatinite, dihydrophosphate, fluoride, formate, hydrophosphate, hydroxide, iodide, nitrate, nitrite, perchlorate, phosphate, phosphite, sulfate, sulfite, or combinations thereof. Some of these components also form basic solutions in water and therefore are useful in all the applications described herein.

For fuel cell use, the electrolyte is selected to function both as an electrolyte and a reactant in the fuel cell. Typically, compounds that provide hydroxide ion in solution meet this role. For example, many fuel cells operate by the reaction of H₂ with OH⁻ at the anode to form H₂O and electrons, thus soluble hydroxide salts such as KOH, and compounds that produce hydroxide ion upon dissolution in water, e.g. K₂CO₃, are especially useful here. While not intending to be bound by the following statement, it is believed that this component functions as both a reactant and an electrolyte. For example, as reactants, KOH and K₂CO₃ are useful for the production of hydrogen or a fuel cell anode reactant when their solutions are placed in contact with an aluminum-containing composition. Additionally, KOH and K₂CO₃ are useful as electrolytes, i.e. an electron transport medium, lowering the internal resistance of a cell and allowing electrons to move between the anode and cathode.

### Selection of Composition Components

The examples contained herein are illustrative of the compositions of the present invention and are not to be construed as limiting in any way either the spirit or scope of the present invention.

### Component A: Transition Metal Elements

The compositions of the present invention also comprise one or more of the transition metal elements, namely one or more of the groups 1B, 2B, 3B, 4B, 5B, 6B, 7B, and 8B elements. These elements include scandium, yttrium, lanthanum, actinium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, gold, zinc, cadmium, and mercury.

Preferably, the transition metal component of the compositions of the present invention comprises one or more of the group 8B transition metals iron, ruthenium, osmium, cobalt, rhodium, iridium, nickel, palladium, platinum, silver or gold. More preferably, the transition metal component of the compositions comprises one or more of nickel, palladium, or platinum. More preferably still, the transition metal component of the compositions comprises nickel.

Nickel is the preferred transition metal for several reasons, including its resistance to corrosion by base, its high catalytic activity, and its relative cost as compared with other transition metals. Other transition metal elements, particularly palladium and platinum are also useful either by themselves or in combination with nickel. As circumstances change, such as the relative cost of a transition metal element, the use of other transition elements may be more preferred.

### Components B and C: Aluminum and Group 1A Alkali Metal Components

While it is not necessary to include these optional components in the compositions of the present invention, it is preferable to do so when using these compositions for the production of hydrogen gas. It is observed that optional components B and C result in a greater initial rate of hydrogen gas production as compared to a composition containing only components A, D and E.

There are several guidelines for selecting these components of the compositions of the present invention and their relative proportions. It is convenient herein to describe the weight percentages of alkali metal plus aluminum in a composition, and these percentages apply to those compositions that contain both of these components, as well as those compositions that contain only aluminum or only alkali metal.

It is believed that aluminum and the group 1A alkali metals are the composition components that affect the initial rate of hydrogen gas formation. Therefore, hydrogen is generated more rapidly from the compositions that contain a higher proportion of these two components. In an embodiment designed to maximize the initial rate of hydrogen produced per unit weight of alloy, the weight percent of group 1A alkali metal plus aluminum can be about 95-98% of the entire composition by weight. In an embodiment designed for a slower initial rate of hydrogen gas release, the weight percent of group 1A alkali metal plus aluminum can be about 4% of the entire composition by weight. Relatively low percentages of group 1A alkali metal plus aluminum minimize the risk of accidentally contacting the alloys with water. Alloy compositions within this entire range of 4% to 98% are operative, and the weight percent of group 1A alkali metal plus aluminum can be adjusted to either maximize or moderate that rate of hydrogen production.

A preferred weight percent of group 1A alkali metal plus aluminum is therefore from about 4% to about 98% of the entire composition. In an embodiment designed to maximize the amount of hydrogen produced per unit weight of composition, a more preferred weight percent of alkali metal plus aluminum is from about 50% to about 95%, with a more preferred weight percent of from about 80% to about 95% of the entire composition.

In an embodiment designed to moderate the rate of hydrogen gas release, a more preferred weight percent of alkali metal plus aluminum is from about 4% to about 50% of the entire composition, with a most preferred weight percent of from about 30% to about 50%.

In addition to the weight percentage of group 1A alkali metal and aluminum to the total composition weight, the relative ratio of these components to each other can be important in formulating those compositions that contain both components. In this case, it is convenient to describe the ratio of alkali metal to aluminum in terms of their mole ratio or atomic ratio. The alkali metal:aluminum mole ratio can vary from about 10:1 to about 1:10, and the mole ratios can be adjusted continuously in this range. A preferred mole ratio of the alkali metal:aluminum is from about 5:1 to about 1:5, with a more preferred mole ratio of from about 3:1 to about 1:3, with a yet more preferred mole ratio of from about 3:1 to about 1:1. Two most preferred mole ratios of the alkali metal:aluminum are about 3:1 and about 1:1.

In selecting the group 1A alkali metal component of those compositions of the present invention that contain an alkali metal, factors such as the extent of metallurgical solubility of the alkali metal in the other alloy components, and the relative expense of the alkali metal are considerations that may affect the choice of alkali metal. Thus, the preferred group 1A alkali metals are lithium, sodium, potassium, rubidium, and cesium. The more preferred alkali metals are lithium, sodium, and potassium. The still more preferred alkali metals are lithium and sodium. The most preferred alkali metal with respect to its solubility in aluminum, is lithium. Any of these alkali metals may be used alone or in combination with other alkali metals in those alloys of the present invention that contain an alkali metal.

### Component D: Component Having a High Mobility Value for Electrons

The compositions of the present invention also comprise one or more elements or compounds having high mobility values for electrons. Although these elements or compounds are also referred to herein as semiconductors, the preferred method of characterizing them is with respect to their actual electron mobility values. Semiconductor materials that are operative in the alloys of the present invention include, but are not limited to C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃, and/or Te. Table 1 (adapted from the CRC Handbook of Chemistry and Physics, David R. Lida, Editor-in-Chief, CRC Press, 71st Ed., 1990-91) presents the electron mobility values for many of these elements and compounds. The selection of high electron mobility components among the possible choices may be aided by considering their electron mobility values, their compatibility with the other composition components, their stability in the presence of oxygen, water, and hydrogen, and their relative expense.

While materials having relatively low electron mobilities may be used in the present invention, components having electron mobilities between about 100 cm²/V.s and about 100,000 cm²/V.s are preferred. More preferred are components having electron mobilities between about 400 cm²/V.s and about 100,000 cm²/V.s. More preferred still are those components having electron mobilities between about 800 cm²/V.s and about 100,000 cm²/V.s. Most preferred are elements and compounds having electron mobilities between about 1,000 cm²/V.s and about 80,000 cm²/V.s. Elements and compounds selected for this component may be used either by themselves or in combination with additional high electron mobility components. One preferred combination of materials having a high mobility value for elections is Ge and InSb.

TABLE 1
Non-limiting Examples of Elements or Compounds
Characterized by a High Electron Mobility Value

| MATERIAL | ELECTRON MOBILITY (cm²/V · s) |
|---|---|
| C - Carbon | 1800 |
| Si - Silicon | 1900 |
| Ge - Germanium | 3800 |
| Sn - Tin | 2500 |
| AgBr - Silver Bromide | 4000 |
| CdTe - Cadmium Telluride | 1200 |
| HgSe - Mercury Selenide | 20000 |
| HgTe - Mercury Telluride | 25000 |
| AlAs - Aluminum Arsenide | 1200 |
| GaAs - Gallium Arsenide | 8800 |
| GaSb - Gallium Antimonide | 4000 |
| InP - Indium Phosphide | 4600 |
| InAs - Indium Arsenide | 33000 |
| InSb - Indium Antimonide | 78000 |
| SiC - Silicon Carbide | 4000 |
| ZnSiP₂ | 1000 |
| CdSiP₂ | 1000 |
| CdSnAs₂ | 22000 |
| CdIn₂Te₄ | 4000 |
| Hg₅In₂Te₈ | 2000 |
| PbSe - Lead Selenide | 1000 |
| PbTe - Lead Telluride | 1600 |
| Bi₂Te₃ - Bismuth Tritelluride | 1140 |
| Te - Tellurium | 1700 |

Preferred semiconductor materials, include, but are not limited to C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃, and/or Te. More preferred semiconductor materials, when using nickel as the transition metal component of the compositions, are Ge, Sn, and InSb. An even more preferred semiconductor material when using nickel as the transition metal component of the alloys is Ge or InSb. A most preferred semiconductor material when using nickel as the transition metal component of the alloys is Ge. Note that the semiconductor material selected for the compositions may be used either by itself or in combination with additional high electron mobility components. A preferred combination of semiconductor materials in the compositions is Ge, InSb, and Sn. A more preferred combination of semiconductor materials in the compositions is Ge and InSb. When InSb is selected as the semiconductor material for a composition, it is typically prepared from its ingredients In and Sb, either melted together as a premelt, or along with other composition components.

### Component E: Source of Ionizing Radiation

The present invention also comprises a source of ionizing radiation configured such that the alloy material is irradiated by the radiation source. Thus, component E of the present invention may comprise a material or a device capable of emitting α-, β-, γ-, or X-radiation. It has been observed that when component E is thorium and is in contact with the alloy composition consisting of the components A, B, C and D as described in Example 3, more hydrogen gas is produced from this composition than in the absence of the radioactive thorium.

When component E is a material that is capable of being processed by one of the melting or deposition techniques described below, it may be incorporated into the alloy composition as a component of the alloy and processed accordingly. This is the case when, for example, component E is a radioactive metal. In this embodiment, component E comprises from about 1% by weight to about 90% by weight of the total weight of the composition comprising A, optionally B, optionally C, D and E, although a more preferred weight percent of component E is from about 1% to about 50%, and an even more preferred weight percent is from about 1% to about 25%.

In an alternative embodiment, the radioactive material may constitute a separate component such as a rod, foil, sheet, wire, powder and so forth, which is placed into contact with the alloy comprising the other components A, optionally B and/or C, and D. This latter embodiment is the typical method of using component E in the present invention. In this embodiment, component E may be in contact with the alloy in any way. For example, if E is a metal foil or wire, it can be wrapped around a sample of the alloy comprising components A, optionally B and/or C, and D. If E is a rod or wire, it can simply be placed in contact with a sample of the alloy. If E is a powder, it can be packed around a sample or the alloy, or admixed with the alloy composition which has been processed into powder form. Processing the composition into powder provides a sample with much greater surface area, and generally increases the amount of hydrogen gas produced upon exposure of the composition to water.

In these latter embodiments, component E comprises from about 1% by weight to about 90% by weight of the total weight of the composition comprising A, optionally B, optionally C, D and E. A more preferred weight percent of component E is from about 5% to about 70%, and an even more preferred weight percent is from about 10% to about 60%. The weight percent of component E in the composition may be adjusted to provide the desired rate of hydrogen and oxygen gas evolution, with more component E providing a greater rate of gas evolution.

Any material which produces ionizing radiation may be utilized in conjunction with the alloys of the present invention. For example, thorium (²³²Th, 100% abundance) is an alpha particle emitter and has a radioactive decay energy of 4.08 MeV with a half-life of 1.4×10¹⁰ years. If thorium is used for component E, then it is generally not desirable to melt thorium as part of the alloy formulation itself, because its high melting point and radioactivity complicates the complexity to the processing and manufacturing of the alloy. Thus, in one embodiment of the present invention, component E comprises thorium metal which is placed into contact with the alloy of the other components. Thorium may be used as a thorium-containing metal rod (about 2% thorium in tungsten) placed in contact with an alloy monolith comprising the other components A, D and optionally B and/or C. However, substantially pure thorium could also be used in the form of a thorium foil placed in contact with an alloy monolith comprising the other components.

Other materials suitable for use as component E of the present invention include, but are not limited to, isotopes of uranium, ruthenium, cesium, krypton, radium, strontium, and tritium, with all other candidates being listed in tables of radioisotopes found in reference materials available to one of ordinary skill in the art. In another embodiment, component E is a device that emits ionizing radiation and is physically configured so as to irradiate the alloy and induce ionization in the alloy. Thus, any device that emits α, β, γ, or X-radiation is suitable for this embodiment.

### Manufacturing and Processing the Alloys of the Present Invention

An examination of the metallurgical phase diagrams for components of the alloys of the present invention suggests that large macrosegregation domains will result from the limited solubilities of some of these components in their desired percentages. Metallalurgical phase diagrams for these components are reported in Binary Alloy Phase Diagrams, 2d Ed., Vols. 1-3, T. M. Massalski, (ASM International 1990), which is incorporated herein by reference. Therefore, the present invention also provides methods of manufacturing the alloys that reduce macrosegregation and that develop a higher degree of homogeneity than would otherwise be possible.

### General Manufacturing Procedures

One concern during the manufacture of the alloys of the present invention is the introduction of potential contaminants, with special attention directed to preventing the introduction of oxygen or water during the manufacturing process. In order to reduce the presence of contaminants, steps were taken to minimize the exposure of the alloy components to reactants such as air or moisture in order to minimize the formation of oxide, hydroxide, and other contaminants.

Therefore, storage, processing, and manipulation of the alloy components, melts, and final alloys were typically carried out either under vacuum or in an inert atmosphere, such as argon. Methods of handling air- and moisture-sensitive compounds are well known to one of ordinary skill in the art as described in the treatise, The Manipulation of Air-Sensitive Compounds, by D. F. Shriver and M. A. Drezdon, 2d ed., John Wiley and Sons: New York (1986), which is incorporated herein by reference. While there are several methods of handling samples under vacuum or in an inert atmosphere, the components of the present invention were typically handled under argon in an inert atmosphere glove box, such as an Aldrich #Z19,671-1, Z40,3769-2, or Z19,429-8 glove box (Milwaukee, Wis.). When samples were removed from the glove box, transferred to the reaction furnace or chamber, and returned to the glove box after melting, they were typically maintained under an inert atmosphere as much as possible.

Alloys of the present invention can be prepared by melting the alloy components in an arc melting furnace, an induction melting furnace, a vapor deposition chamber, a sintering furnace, or other similar methods that are capable of melting the components of the alloy, such methods being well known to one of ordinary skill in the art. While the particular sample containers and crucibles vary among these methods of melting, in all cases the alloy components, melts, and final alloys were typically manipulated either under vacuum or in an inert atmosphere, such as argon, depending upon the sample container and furnace or chamber design. These methods and practices are well known to one of ordinary skill in the art.

In addition, high purity components were utilized in the present invention to minimize the introduction of existing contaminants in the alloy components that might interfere with the efficient operation of the alloy. While not required to obtain alloy activity, using high purity components enhanced the efficiency of the use of the alloy.

After melting the alloy components, some type of physical agitation or stirring is typically applied to assist in achieving a high degree of homogeneity in the sample. The agitation treatments are made while the sample is still in the liquid state. For example, a high degree of physical agitation of the melt accompanies the arc melting process and, to a lesser extent, induction melting. In the case of arc melting, it is typically not necessary to provide any further agitation steps of any kind beyond that inherent in the process itself. For induction melting, additional agitation is useful, but not necessary.

Commercially available sonication units are employed to sonicate the melts at ultrasonic frequencies. The utility of sonication is illustrated by the formation of alloys of lead-aluminum and lead-tin-zinc using ultrasonic techniques, which are difficult to prepare by conventional metallurgical techniques because of the relative insolubility of these metals in each other. In practice, during both the pre-melt(s) and the final melt of these alloys, high frequency sonication is used during the cooling stage, while the metals/compounds are in a liquid state. With rapid cooling, relatively homogeneous alloys are produced.

An audio frequency agitation process, utilizing either speakers or piezos, is also optionally applied to the liquid sample during the cooling step on both the pre-melt and the final melt, to achieve a high degree of physical agitation. As is known in the art, typical audio frequencies are in the range of from 1 Hz to 32,000 Hz. A wave function generator is connected to a preamplifier which is connected to an audio amplifier, with output either through speakers or piezos, with a power range of from 15 to 30 watts, with more power being applied to larger samples. As in other agitation methods, audio frequency stirring is used on both pre-melts and final melts of the alloys while the sample is still in the liquid state.

The sonication and/or agitation treatments are applied to the alloys while maintaining the samples under an inert atmosphere. While it is not necessary to employ both audio frequency agitation and sonication treatments to every alloy, the ability to impart physical perturbation at different frequencies proves useful to achieve homogeneity for different samples. After cooling is complete such that the sample can be handled safely, the crucible is transferred to an inert atmosphere in a glove box to minimize exposure of the sample to the air during further processing.

Any conventional heat treatment or method known to one skilled in the art to reduce macrosegregation within alloys may be employed to improve homogeneity of the alloy samples of the present invention. As an option, and depending upon the final application of a particular alloy sample, special cooling techniques are utilized to improve the final product. For example, rapid cooling methods, such as pouring the alloy samples over a cold drum, or maintaining the samples in a cold copper crucible, are all practical methods that allow for the rapid cooling of samples, which often provide amorphous as opposed to crystalline samples.

After melting, the gas/vacuum handling system of the particular furnace and crucible is used to place the samples under an inert atmosphere or under vacuum, for further processing. Typically, the samples are transferred back to a glove box for further processing. All post-preparatory procedures, such as machining the alloy samples, weighing the samples, refractory coating of crucibles (if appropriate), and sealing and storing samples in suitable storage containers, are also carried out under an inert atmosphere.

### Arc Melting

The arc melting furnace, as used in the present invention, includes a system of melting elements, compounds, alloys, etc., through the use of a high current potential being developed between two juxtaposed electrodes. A typical arc melting system includes a vacuum chamber, a cold copper plate/crucible that functions as both an electrode surface and a surface in which the melting is achieved, an upper movable electrode which can be located near the plate/crucible, and a power supply.

The arc melting system of the present invention involves the following steps. The alloy components, which were stored and processed under an inert atmosphere, were loaded into an arc melting crucible and then placed into the vacuum chamber portion of the arc melting furnace with minimal exposure of the sample to the atmosphere. The vacuum chamber was sealed, placed under a dynamic vacuum for several minutes and then refilled with argon. This pump and refill cycle was repeated one or two more times to achieve thorough removal of any remaining gaseous contaminants from the chamber. The upper, moveable electrode was placed into position and the furnace was powered to achieve an arc to meet the sample.

In some alloys it was desirable to form intermediate alloys or “pre-melts” comprising a subset of the alloy components, and thereafter use the intermediate alloy(s) in a subsequent arc melting step along with the remaining alloy components. When pre-melts were used, each pre-melt alloy was handled and processed in the same fashion as a final melt alloy. Thus, after a pre-melt, the intermediate alloy was cooled until it could be handled safely, combined with the remaining alloy components, and then subjected to the arc melting furnace in the same manner. The Examples presented herein illustrate some of the specific pre-melts alloys used in the present invention.

Typically, sufficient physical agitation accompanied the arc melting process to afford the preferred high sample homogeneity. In one embodiment of this invention, an arc melting furnace is fitted with mixing, agitation, or sonication equipment, as described above. After cooling was complete such that the sample could be handled safely, the crucible was transferred to an inert atmosphere in a glove box to minimize exposure of the sample to the air during further processing.

Any conventional heat treatment or method known to one skilled in the art to reduce macrosegregation within alloys may be employed to improve homogeneity of the alloy samples of the present invention.

### Induction Melting

As known to one of ordinary skill in the art, induction melting as used in the present invention includes a method of melting elements, compounds, alloys, etc., through the use of a high current, high frequency potential being developed in a copper coil. An insulated crucible, with an example being a graphite tube crucible with a quartz sheath, is placed in the inner diameter of the copper coils. Typical induction melting equipment includes a power supply (4 KHz and above), various diameter copper coils, and glove box/vacuum chambers if necessary.

Induction melting typically involves placing the alloy components in an insulated graphite crucible in a quartz sheath which was then placed in the inner diameter of the copper coils of the induction melting furnace under an inert atmosphere. Melting is accomplished under a blanket of argon gas (1 atmosphere pressure). The induction melting furnace is powered until the sample was completely melted, usually for several minutes depending upon sample size. Power to the furnace is then removed once the sample is allowed to cool until it can be handled safely.

As described above for the arc melting procedure, it is often desirable to prepare pre-melts comprising a subset of the alloy components, and thereafter use the pre-melt alloy in an induction melting step along with the remaining alloy components. When pre-melts are used, each pre-melt alloy is handled and processed in the same fashion as a final melt alloy. The induction melting procedure optionally utilizes a series of physical agitation and/or sonication treatments to achieve a high degree of homogeneity in the sample as described above. Any conventional heat treatment or other methods known to one skilled in the art may be utilized to reduce macrosegregation within the alloys, as described above for arc melting.

### Vapor Deposition

Vapor deposition, as used in the present invention, refers to methods in which materials (elements, compounds, alloys, etc.) are vaporized into the gas phase and then condensed or deposited onto a substrate (ceramic, plastic, etc.) through the use of a combination of vaporizing beam and target. As well known to one of ordinary skill in the art, a variety of vapor deposition techniques are available. For example, one vapor deposition technique utilizes an electron beam which strikes a metal target (e.g. aluminum) with a known amount of energy, thereby imparting sufficient energy to that target to cause an amount of material to leave the target surface and become a vapor. This vapor is then deposited onto a given substrate at a known thickness and rate.

With respect to the present invention, vapor deposition involves the following steps. First, the alloy components are processed under an inert atmosphere (in a glove box) into the proper form (size, shape, etc.) to constitute a target for the particular vapor deposition equipment being used. Once in the proper form, the vapor deposition target(s) are transferred to the vacuum chamber portion of the deposition equipment, while maintaining the target material under an inert atmosphere to the extent possible. To accomplish this task, the target(s) may simply be packaged in an airtight, argon filled container for transfer to the deposition chamber. The vapor deposition chamber is sealed, a vacuum is created, and the chamber is maintained under a high vacuum during the vapor deposition process.

Just as the pre-melts are desirable in the melting procedures described above, it may be desirable in the vapor deposition process to utilize a series of pre-sputters and alloy layers, before the final sputter. By way of example, in an alloy of the present invention comprising nickel, aluminum, lithium and germanium, one method of alloy manufacture uses three separate sputtering targets, one target of nickel-aluminum alloy, a second target of lithium, and a third target of germanium. During a pre-sputter process, a primer layer of one of these elements or alloy is applied to the substrate to yield a desired beneficial effect for the final sample, such as good adhesion to the substrate. Next, the final sputter utilizes all three targets to build up a coating of the final alloy. The final sputter step is repeated until the desired thickness of the alloy has been attained.

One advantage of sputtering over conventional metallurgical techniques is that extremely homogeneous samples may be obtained. Because the layers of material applied may be made extremely thin (approximately 100 angstroms) and because the time involved for the sample to cool is extremely rapid, the problems of homogeneity in this alloy system are virtually eliminated. As known to one of ordinary skill in the art, certain treatments and conditioning procedures may be made to the substrate to help insure homogeneity in this alloy system.

A further advantage of sputtering over conventional metallurgical techniques is the ability to apply protective coatings to a final alloy sample. For example, it is often desirable to apply a protective layer to the final alloy sample, for example a silicone layer, to prevent the alloy sample from reacting with the moisture in the ambient air. The vapor deposition process is well adapted to achieve this goal.

### Sintering

In addition to the arc melting, induction melting, and vapor deposition techniques described above, the alloys of the present invention may be manufactured by the process of sintering. This method, which is well known to one of ordinary skill in the art, involves thorough mixing of the components of the final alloy, in the proportions desired in the final alloy. The ingredients are mixed in the form of powders until a homogeneous mixture is obtained. Pressure is then applied to a sample of this mixture at pressures from about 10,000 to 100,000 pounds per square inch using, for example, a steel dye. The compressed material is then heated in an oven at sufficiently high temperatures to fuse the alloy.

### Use of the Compositions for Electrode Materials

### Battery Anode Comprising the Compositons of the Present Invention

The compositions of the present invention are utilized in a battery that is designed and constructed according to standard battery designs known to one of ordinary skill in the art. Batteries of this design, employing the compositions of the present invention, are capable of achieving high energy densities. The anode of such a battery comprises the composition of the present invention, and the cathode of the battery comprises any common cathode material, typically carbon, the selection and design of which are well known to one skilled in the art. One example of cathode material that may be used in a battery is the carbon electrode found in zinc-air batteries. Typically, the anode incorporates the composition components A, B and/or C, and D of the present invention, and component E is used as a separate component which is placed in contact with the anode. In one embodiment, the source of ionizing radiation comprises a tungsten rod comprising about 2% thorium.

By way of example, an electrolyte such as an aqueous alkali metal salt is used, although the present invention anticipates the use of solution, paste, and other types of electrolytes known to one of ordinary skill in the art. If the composition of the present invention used to make the anode contains an alkali metal, then any suitable soluble salt well known to one of ordinary skill in the art is used in the aqueous electrolyte. If the composition of the present invention used to make the anode does not contain an alkali metal, then a salt containing hydroxide ion, typically potassium hydroxide, is used in the aqueous electrolyte.

### Capacitor Anode Comprising the Compositions of the Present Invention

The compositions of the present invention may also be used in a capacitor/battery device of similar design as hybrid capacitor/battery devices in the relevant art, to achieve high energy densities. In such devices, the anode of this capacitor/battery is typically made of a combination anode comprising the composition of the present invention and high surface area carbon foams as used in super capacitor or ultra capacitor technologies known to one of ordinary skill in the art. The anode typically incorporates components A, B and/or C, and D of the present invention, and component E is used separately and is placed in contact with the composition anode. In one embodiment, the source of ionizing radiation comprises a tungsten rod comprising about 2% thorium.

The composite is constructed such that samples of composition anode and carbon foam materials are brought into contact along one edge of each material, such that a single monolith comprising two portions is formed. Alternatively, a carbon foam electrode that is impregnated with the composition of the present invention may be employed. One carbon foam employed in such capacitor devices is manufactured by Mitsushita (Kyoto, Japan) and utilized in the Panasonic super capacitor EECA OEL 106 rated at 2.5V at 10 farads. The cathode of the capacitor comprises any common cathode material, typically carbon, the selection and design of which are well known. One example of cathode material is the carbon electrode found in zinc-air batteries. A dielectric material separating the anodic and cathodic half-cells is typically used, depending upon the particular capacitor design.

An electrolyte such as an aqueous alkali metal salt is used, although the present invention anticipates the use of solution, paste, and other types of electrolytes known to one of ordinary skill in the art. If the alloy of the present invention used to make the anode comprises an alkali metal, then any suitable soluble salt well known to one of ordinary skill in the art may be used in the aqueous electrolyte. If the alloy of the present invention used to make the anode does not contain an alkali metal, then a salt containing hydroxide ion, typically potassium hydroxide, is used in the aqueous electrolyte.

The difference between the battery and the capacitor hybrid is that electrons from the composition begin to accumulate along the surface of the carbon foam. Due to the high surface area of the carbon foam material and its operating characteristics, a high peak current is possible when discharging this device through a load. This hybrid capacitor device, like a capacitor, may be recharged from an external power source, however, this capacitor hybrid recharges itself over time as a result of the battery incorporated within its design.

### Fuel Cells Comprising the Compositions of the Present Invention

The compositions of the present invention are also utilized in a hybrid battery/fuel cell that is designed and constructed according to standard fuel cell designs known to one skilled in the art, to achieve high energy densities. The anode of the fuel cell was constructed in one of two ways. In one embodiment, the anode comprises the composition of the present invention, in contact with component E such as a thorium foil or thorium-containing rod, and also in contact with a standard platinum black electrode. Moreover, these anode components are disposed where the hydrogen and oxygen gas produced at the composition portion of the anode contact the platinum black portion of the anode and thereby serve as a fuel for the fuel cell. In a second embodiment, the anode comprises the composition of the present invention, wherein the composition contains platinum as one of its components. Thus, the platinum serves to convert the hydrogen to water in the operation of the fuel cell.

The cathode of the fuel cell comprises any common fuel cell cathode material, the selection and design of which are well known to one of ordinary skill in the art. The cathode was contacted with oxygen that comprises the oxidant for the fuel cell system and is itself reduced to hydroxide during the operation of the fuel cell. An aqueous electrolyte comprising an alkali metal salt is used in this system. If the composition of the present invention used to make the anode contains an alkali metal, then any suitable soluble salt may be used in the aqueous electrolyte, the selection of which is well known to one of ordinary skill in the art. If the composition of the present invention used to make the anode does not contain an alkali metal, then a salt containing hydroxide ion, typically potassium hydroxide, is used in the aqueous electrolyte.

When the composition anode of the present invention comes into contact with the aqueous electrolyte, reaction between the electrolyte and the composition initiates, and hydrogen was produced. The hydrogen is used in the direct production of energy in this fuel cell system, thus, hydrogen is oxidized at the anode and oxygen is reduced at the cathode.

The compositions of the present invention were also utilized in conjunction with a traditional fuel cell design by employing it solely as a source for hydrogen gas. Thus, upon contacting the compositions of the present invention with water, or aqueous alkali metal hydroxide solutions, hydrogen gas was produced that was utilized by contacting it with the anode of a traditional hydrogen fuel cell system, designs of which are well known to those of skill in the art.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to one of ordinary skill in the art without departing from the spirit of the present invention or the scope of the appended claims.

### EXAMPLE 1

### Preparation of a Composition by Arc Melting

In order to reduce the presence of contaminants in the compositions of the present invention, steps were taken to minimize the exposure of the composition components to reactants such as air and moisture. In addition, high purity components were utilized in the present invention to minimize the introduction of existing contaminants from the individual alloy components that might interfere with the efficient operation of the alloy.

An arc melting crucible was loaded with about 120 g of nickel, 40 g of aluminum, 20 g of lithium, and 20 g of germanium. The crucible was then transferred to the vacuum chamber of the arc melting furnace with minimal exposure of the sample to the atmosphere. The vacuum chamber was placed under a dynamic vacuum for several minutes, and then refilled with argon. This pump and refill cycle was repeated one or two more times to achieve thorough removal of any remaining gaseous contaminants from the chamber. The upper, moveable electrode was placed into position, and the furnace was powered to achieve an arc to melt the sample. Typical power supplies used in this experiment provided approximately 2,000 amps. The moveable electrode was slowly and continuously moved around the sample to facilitate melting and up to a minute thereafter to facilitate mixing.

After this time, power to the furnace was shut off and the sample was allowed to cool for several minutes until it could be handled safely. After cooling was complete, the crucible was transferred to an inert atmosphere glove box or stored under vacuum to minimize exposure of the sample to the atmosphere until further processing.

The alloy produced in this fashion was cut into smaller samples of about 1 g each and placed in contact with an approximately equal weight of thorium-containing metal rod, comprising about 2% thorium in tungsten. This small sample of the thorium-containing composition was placed in contact with distilled water to examine its hydrogen- and oxygen-producing activity. Hydrogen production was confirmed by adding a sample of the composition to a fuel cell (VWR, Atlanta, Ga., Scientific Mini Fuel Cell # WLS30198), contacting the alloy with distilled water, and using a voltmeter to confirm a potential of 1 V across the cell in a no-load configuration.

### EXAMPLE 2

### Preparation of a Composition by Arc Melting using Pre-Melts

In some embodiments of this invention, it was desirable to form intermediate alloys comprising a subset of the composition components, and thereafter use this intermediate alloy in a subsequent arc melting step along with the remaining components. This example illustrates the use of such an intermediate alloy or “pre-melt” of nickel and aluminum. In an inert atmosphere dry box, an arc melting crucible was loaded with 120 g of nickel and 40 g of aluminum. This sample was handled and melted in the manner described in Example 1.

After cooling, the intermediate nickel-aluminum alloy, which appeared homogeneous, was combined with the remaining alloy components, 20 g of lithium and 20 g of germanium, and then melted in the arc melting furnace in the same manner described in Example 1. Further processing was carried out as outlined in Example 1.

The alloy produced in this fashion was cut into smaller samples of about 1 g each and placed in contact with an approximately equal weight of thorium-containing metal rod, comprising about 2% thorium in tungsten. This small sample of the thorium-containing composition was placed in contact with distilled water to examine its hydrogen- and oxygen-producing activity. Hydrogen production was confirmed by adding a sample of the composition to a fuel cell (VWR, Atlanta, Ga., Scientific Mini Fuel Cell # WLS30198), contacting the alloy with distilled water, and using a voltmeter to confirm a potential of 1 V across the cell in a no-load configuration.

### EXAMPLE 3

### Preparation of a Composition by Arc Melting using Pre-Melts

The components and the composition itself made in this Example were handled in the manner described above in Example 1. A pre-melt alloy was prepared from 19.4 g of indium and 20.6 g of antimony in an arc melting furnace, as described above in Examples 1 and 2. This pre-melt alloy was combined with 1.0 g of lithium, 5 g of palladium, 20 g of aluminum, and 34 g of tin in an arc melting crucible, and then melted in an arc melting furnace as described above in Example 1.

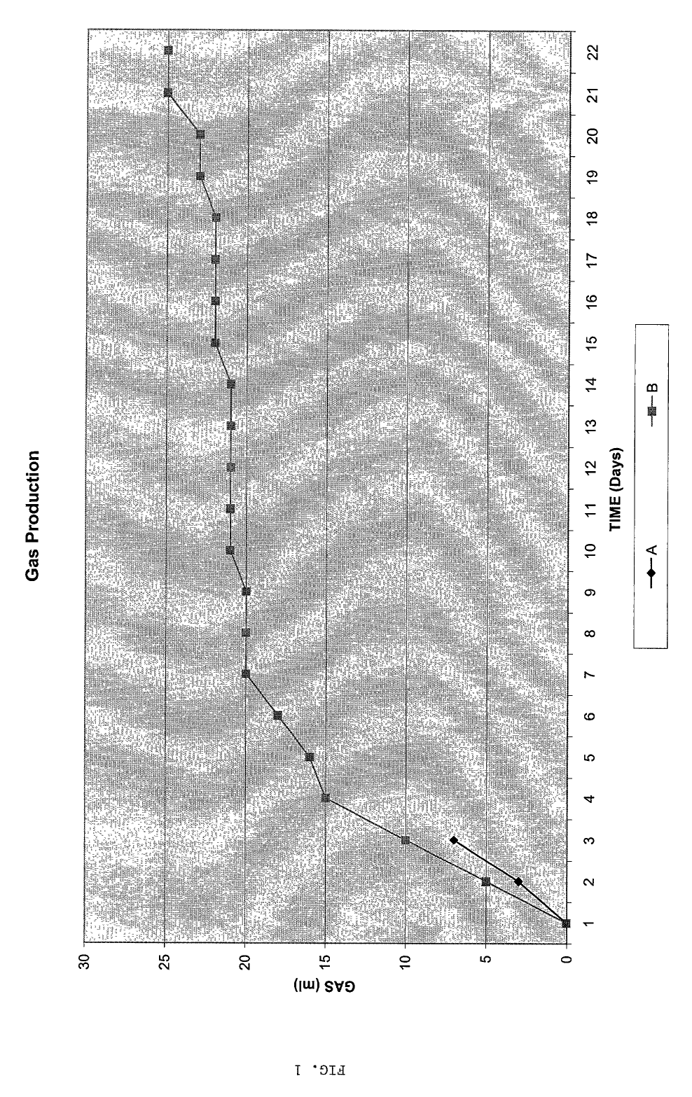

A 4.3-gram sample of the alloy produced in this fashion was placed in contact with a 5.0-gram sample of thorium-containing metal rod, comprising about 2% thorium and 98% tungsten. This sample of the thorium-containing composition was placed in contact with distilled water to examine its hydrogen- and oxygen-producing activity. Hydrogen production was confirmed by adding a sample of the composition to a fuel cell (VWR, Atlanta, Ga., Scientific Mini Fuel Cell # WLS30198), contacting the alloy with distilled water, and using a voltmeter to confirm a potential of 1 V across the cell in a no-load configuration. FIG. 1 demonstrates the hydrogen-production activity of this composition with and without the thorium-containing metal rod, demonstrating that hydrogen gas if released at a faster rate when thorium is in contact with the alloy than when thorium is absent.

### EXAMPLE 4

### Preparation of a Composition by Arc Melting

The components and the composition itself made in this Example were handled in the manner described above in Example 1. A first pre-melt alloy was prepared from 12 g of nickel and 40 g of aluminum to prepare an intermediate alloy or “pre-melt” as described above in Examples 1 and 2. A second pre-melt alloy was prepared from 58.2 g of indium and 61.8 g of antimony in an arc melting furnace, as described above for the nickel-aluminum pre-melt alloy. Both these pre-melt alloys were further used in the final melt alloy.

The nickel-aluminum pre-melt alloy and the indium-antimony pre-melt alloy were combined with 20 g of lithium and 8 g of germanium in an arc melting crucible, and then melted in an arc melting furnace as described above in Example 1.

The alloy produced in this fashion was cut into smaller samples of about 1 g each and placed in contact with an approximately equal weight of thorium-containing metal rod, comprising about 2% thorium in tungsten. This small sample of the thorium-containing composition was placed in contact with distilled water to examine its hydrogen- and oxygen-producing activity. Hydrogen production was confirmed by adding a sample of the composition to a fuel cell (VWR, Atlanta, Ga., Scientific Mini Fuel Cell # WLS30198), contacting the alloy with distilled water, and using a voltmeter to confirm a potential of I V across the cell in a no-load configuration.

### EXAMPLE 5

### Preparation of a Composition by Induction Melting

To reduce the presence of contaminants in the compositions, samples were handled under argon and high purity components were utilized whenever possible. Melting of the components in this Example was accomplished by induction melting, which involves the use of a high current, high frequency potential which is developed in a copper coil, the operation of which is well known to one of ordinary skill in the art. The sample was loaded into an insulated, graphite tube crucible with a quartz sheath, which was placed in the inner diameter of the copper coil. Melting was accomplished under a blanket of argon gas (1 atmosphere pressure). The induction melting furnace was powered until the sample was completely melted, usually for several minutes depending upon sample size. Power to the furnace was removed and the sample was allowed to cool until it could be handled safely. Like the arc melting furnace procedure of Example 1, this induction melting procedure allowed for pre-melts as well as final melts.

An induction melting crucible was loaded with 20 g of nickel, 40 g of aluminum, 20 g of lithium, 58.2 g of indium, and 61.8 g of antimony. These materials were then loaded into the induction furnace while minimizing their exposure to the atmosphere and placed under a slow, continuous flow of argon gas (1 atmosphere). The sample was melted as described above to form the alloy.

The alloy produced in this fashion was cut into smaller samples of about 1 g each and placed in contact with an approximately equal weight of thorium-containing metal rod, comprising about 2% thorium in tungsten. This small sample of the thorium-containing composition was placed in contact with distilled water to examine its hydrogen- and oxygen-producing activity.

Hydrogen production was confirmed by adding a sample of the composition to a fuel cell (VWR, Atlanta, Ga., Scientific Mini Fuel Cell # WLS30198), contacting the alloy with distilled water, and using a voltmeter to confirm a potential of 1 V across the cell in a no-load configuration.

### EXAMPLE 6

### Preparation of a Composition by Induction Melting using Pre-Melts

An induction furnace crucible was loaded with 13.4 g of nickel and 17.0 g of palladium and an intermediate alloy or “pre-melt” was prepared in an induction furnace as described in Example 4. A second pre-melt alloy was prepared from 37.6 g of indium and 40.0 g of antimony in an induction furnace, under an inert atmosphere, as described. Both these pre-melt alloys were further used in the final melt alloy.

The nickel-palladium pre-melt alloy and the indium-antimony pre-melt alloy were combined with 6.0 g of aluminum, 3.0 g of lithium, 7.0 g of germanium, and 76.0 g of tin in the induction furnace crucible. This final melt alloy was melted in the induction furnace as described above in Example 4.

The alloy produced in this fashion was cut into smaller samples of about 1 g each and placed in contact with an approximately equal weight of thorium-containing metal rod, comprising about 2% thorium in tungsten. This small sample of the thorium-containing composition was placed in contact with distilled water to examine its hydrogen- and oxygen-producing activity. Hydrogen production was confirmed by adding a sample of the composition to a fuel cell (VWR, Atlanta, Ga., Scientific Mini Fuel Cell # WLS30198), contacting the alloy with distilled water, and using a voltmeter to confirm a potential of 1 V across the cell in a no-load configuration.

### EXAMPLE 7

### Processing a Composition in Powder Form

All of the compositions prepared in Examples 1 to 6 above were processed from the block form, as it forms in these Examples, into powder. Processing the compositions into powder provided a sample with much greater surface area, thereby greatly increasing the amount of hydrogen and oxygen gas produced upon exposure of the composition to water.

Samples of the composition prepared in Example 1 were processed into powder form using standard techniques well known to one of ordinary skill in the art. Thus, samples of 100 mesh, 400 mesh, 3 micron, and 100 nanometer size powder were formed. Each of these samples was placed in contact with water and the generation of hydrogen and oxygen gas were monitored. The 100 mesh powder produced more gas than the same amount of alloy in block form. The 400 mesh powder produced more gas than the same amount of 100 mesh alloy. The 3 micron powder alloy produced even more hydrogen and oxygen gas than the 100 or 400 mesh samples. The 100 nanometer powder produced the most hydrogen and oxygen gas.

### EXAMPLE 8

### Composition in a Battery Electrode

Any of the compositions of the present invention is utilized in a battery that is designed and constructed according to standard battery designs known to one of ordinary skill in the art, to achieve high energy densities. The anode of the battery comprises the composition of the present invention. The cathode of the battery comprises any common cathode material, typically carbon, the selection and design of which are well known. One example of cathode material is the carbon electrode found in zinc-air batteries. By way of example, an electrolyte such as an aqueous alkali metal salt is used, although the present invention anticipates the use of solution, paste, and other types of electrolytes known to one of ordinary skill in the art. If the composition of the present invention used to make the anode comprises an alkali metal, then any suitable soluble salt may be used in the aqueous electrolyte, the selection of which is well known to one of ordinary skill in the art. If the composition of the present invention used to make the anode does not comprise an alkali metal, then a salt containing hydroxide ion, typically potassium hydroxide, must be used in the aqueous electrolyte. An “activation strip” of insulator material is removably attached along one surface of the anode to prevent contact between the anode and the electrolyte of the battery before the battery is ready for use. This insulator material is then removed to allow contact between the anode and the electrolyte and thereby activate the battery.

In order to prevent the electrolyte from drying out as a result of the reaction of the electrolyte solution with the alloy, a means for oxidizing the hydrogen gas produced within this system is provided within the battery. Any of the well-known methods disclosed in the prior art may be utilized for this purpose. One such method is to use a platinum coated surface to allow the platinum to convert the hydrogen to water catalytically, in the presence of ambient oxygen. Another method employs a small amount of platinum into the alloy itself, obviating the need for any additional structures within the battery enclosure. Another method utilizes a material other than platinum, such as silver oxide, as described in the prior art.

### EXAMPLE 9

### Composition in a Capacitor Electrode

Any of the compositions of the present invention is useful in a capacitor/battery device of similar design as the hybrid capacitor/battery devices in the relevant art, to achieve high energy densities. In such devices, the anode of this capacitor/battery is made of a composite of the composition of the present invention and high surface area carbon foams as used in super capacitor or ultra capacitor technologies known to one skilled in the art. The composite is constructed such that samples of composition and carbon foam materials are brought into contact along one edge of each material, such that a single monolith comprising two portions is formed. Alternatively, a carbon foam electrode that is impregnated with the composition of the present invention may be employed. One carbon foam employed in such capacitor devices is manufactured by Mitsushita (Kyoto, Japan) and utilized in the Panasonic super capacitor EECA OEL 106 rated at 2.5V at 10 farads. The cathode of the capacitor comprises any common cathode material, typically carbon, the selection and design of which are well known. One example of cathode material is the carbon electrodes found in zinc-air batteries. A dielectric material separating the anodic and cathodic half-cells is typically used, depending upon the particular capacitor design.

An electrolyte, such as an aqueous alkali metal salt is used, although the present invention anticipates the use of solution, paste, and other types of electrolytes known to one skilled in the art. If the composition of the present invention used to make the anode comprises an alkali metal, then any suitable soluble salt may be used in the aqueous electrolyte, the selection of which is well known to one of ordinary skill in the art. If the composition of the present invention used to make the anode does not comprise an alkali metal, then a salt containing hydroxide ion, typically potassium hydroxide, must be used in the aqueous electrolyte.

In order to prevent the electrolyte from drying out as a result of the reaction of the electrolyte solution with the composition, a means for oxidizing the hydrogen gas produced within this system is provided within the battery. Any of the well-known methods disclosed in the prior art may be utilized for this purpose. One such method is to use a platinum coated surface or platinum mesh to allow the platinum to convert the hydrogen to water catalytically, in the presence of ambient oxygen. Another method employs a small amount of platinum into the composition itself, obviating the need for any additional structures within the battery enclosure. Another method utilizes a material other than platinum, such as silver oxide, as described in the prior art.

The difference between the battery of Example 8 and the capacitor hybrid of this Example is that electrons from the alloy begin to accumulate along the surface of the carbon foam. Due to the high surface area of the carbon foam material and its operating characteristics, a high peak current is possible when discharging this device through a load. This hybrid capacitor device, like a capacitor, may be recharged from an external power source, however, this capacitor hybrid will also recharge itself over time as a result of the battery incorporated within its design.

### EXAMPLE 10

### Composition in a Fuel Cell Electrode and as a Fuel Source in a Hybrid Battery/Fuel Cell

The composition of Example 1 of the present invention is utilized in a hybrid battery/fuel cell that is designed and constructed according to standard fuel cell designs known to one skilled in the art, to achieve high energy densities. The anode of the fuel cell is constructed in one of two ways. In one embodiment, the anode comprises the composition of the present invention, in contact with a standard platinum black electrode. Moreover, these two anode components are disposed where the hydrogen gas produced at the composition portion of the anode contacts the platinum black portion of the anode and thereby serves as a fuel for the fuel cell. In a second embodiment, the anode comprises the composition of the present invention, wherein the composition contains platinum as one of its components. Thus, the platinum serves to convert the hydrogen to water in the operation of the fuel cell. The cathode of the fuel cell comprises any common fuel cell cathode material, the selection and design of which are well known. The cathode is contacted with oxygen that comprises the oxidant for the fuel cell system and is itself reduced to hydroxide during the operation of the fuel cell. An aqueous electrolyte comprising an alkali metal salt is used in this system. If the composition of the present invention used to make the anode comprises an alkali metal, then any suitable soluble salt may be used in the aqueous electrolyte, the selection of which is well known to one of ordinary skill in the art. If the alloy of the present invention used to make the anode does not comprise an alkali metal, then a salt containing hydroxide ion, typically potassium hydroxide, is used in the aqueous electrolyte. An “activation strip” of insulator material is removably attached along one surface of the composition anode to prevent contact between the anode and the electrolyte of the fuel cell before it was ready for use. This insulator material was removed to allow contact and thereby activate the fuel cell.

Upon removal of the activation strip, the anode of the present invention comes into contact with the aqueous electrolyte, reaction initiates between the electrolyte and the composition, and hydrogen is produced. The hydrogen is used in the direct production of energy in this fuel cell system, thus, hydrogen is oxidized at the anode and oxygen is reduced at the cathode.

This fuel cell system comprises an inherent method to prevent the electrolyte from drying out as a result of the reaction of the electrolyte solution with the composition, namely, an internal means for oxidizing the hydrogen gas produced within the system.

### EXAMPLE 11

### Composition as a Hydrogen Source for a Fuel Cell

Any composition of the Examples of the present invention was utilized in conjunction with a traditional fuel cell design by employing it solely as a source for hydrogen gas. Thus, upon contacting the compositions of Examples 1-5 of the present invention with water, or aqueous alkali metal hydroxide solutions, hydrogen gas was produced that was utilized by contacting it with the anode of a traditional hydrogen fuel cell system, designs of which are well known to those of skill in the art. In a typical experiment, an alloy of the present invention was added to a fuel cell (VWR, Atlanta, Ga., Scientific Mini Fuel Cell # WLS30198) which employed a platinum black anode (VWR # AA12755-03) and a carbon cathode (VWR # WLS30198). Upon contacting a composition with either water or aqueous hydroxide ion, hydrogen was produced and a voltmeter was to confirm a potential across the cell.

### EXAMPLE 12

### Preparation of Compositions Without Alkali Metal

The alloy compositions presented in Table2, all of which contain no added alkali metal as an ingredient, are prepared using any of the processing techniques described earlier in the Detailed Description, including arc melting, induction melting, vapor deposition, and sintering, although arc melting is the preferred method. A portion of this alloy sample is placed in contact with a thorium-containing metal rod, comprising about 2% thorium in tungsten (which is not indicated in the Table). This thorium-containing sample is then placed into contact with water or aqueous base to produce hydrogen. Since these alloys do not contain an alkali metal, aqueous hydroxide ion, typically aqueous potassium hydroxide, is used to contact the alloys to produce hydrogen gas. A voltmeter is used to confirm a potential of 1 V across the cell in a no-load configuration, from which the production of hydrogen gas is inferred.

TABLE 2
Percent Composition by Weight of Alloys
of the Present Invention that Contain No Added Alkali Metal^{§}

| Example | Transition | Aluminum | Alkali | Semi- |
|---|---|---|---|---|
| No. | Metal (A) | (B) | Metal (C) | conductor (D) |
| 12.1 | 70% Ni | 20% Al | — | 10% Ge |
| 12.2 | 16% Ni | 20% Al | — | 4% Ge |
| | | | | 29.1% In |
| | | | | 30.9% Sb |
| 12.3 | 20% Ni | 20% Al | — | 29.1% In |
| | | | | 30.9% Sb |
| 12.4 | 8.2% Ni | 3% Al | — | 20% Sb |
| | 8.5% Pd | | | 18.8% In |
| | | | | 3.5% Ge |
| | | | | 38% Sn |
| 12.5 | 5% Ni | 90% Al | — | 5% Ge |
| 12.6 | 1% Pd | 95% Al | — | 1.94% In |
| | or Pt | | | 2.06% Sb |

^{§}The alloys presented in this table are placed in contact with thorium.

### EXAMPLE 13

### Preparation of a Composition Without Aluminum

The alloy compositions presented in Table3, all of which contain no added aluminum as an ingredient, are prepared using any of the processing techniques described earlier in the Detailed Description, including arc melting, induction melting, vapor deposition, and sintering. Arc melting is the preferred method. A portion of this alloy sample is placed in contact with a thorium-containing metal rod, comprising about 2% thorium in tungsten (which is not indicated in the Table). This thorium-containing sample is then placed into contact with water to produce hydrogen. A voltmeter is used to confirm a potential of 1 V across the cell in a no-load configuration, from which the production of hydrogen gas is inferred.

TABLE 3
Percent Composition by Weight of Alloys
of the Present Invention that Contain No Added Alkali Metal^{§}

| Example | Transition | Aluminum | Alkali | Semi- |
|---|---|---|---|---|
| No. | Metal (A) | (B) | Metal © | conductor (D) |
| 13.1 | 80% Ni | — | 10% Li | 10% Ge |
| 13.2 | 26% Ni | — | 10% Li | 4% Ge |
| | | | | 29.1% In |
| | | | | 30.9% Sb |
| 13.3 | 30% Ni | — | 10% Li | 29.1% In |
| | | | | 30.9% Sb |
| 13.4 | 9.7% Ni | — | 1.5%Li | 20% Sb |
| | 8.5% Pd | | | 18.8% In |
| | | | | 3.5% Ge |
| | | | | 38% Sn |
| 13.5 | 5% Ni | — | 90% Li | 5% Ge |
| 13.6 | 1% Pd | — | 60% Na | 35% Sn |
| | or Pt | | or K | 1.94% In |
| | | | | 2.06% Sb |

^{§}The alloys presented in this table are placed in contact with thorium.

It should be understood, of course, that the foregoing relates only to preferred embodiments of the present invention and that numerous modifications and alterations may be made therein without departing from the spirit and the scope of the invention. In particular, one skilled in the art will understand the amount and relative proportions of components used in the compositions of the present invention, as well as operating parameters for using these compositions in their various applications.

What is claimed is:

1. A composition comprising:
at least one transition metal;
at least one high electron mobility component; and
a source of ionizing radiation.

2. The composition of claim 1, wherein the transition metal is iron, ruthenium, osmium, cobalt, rhodium, iridium, nickel, palladium or platinum.

3. The composition of claim 1, wherein the high electron mobility component is C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃ or Te.

4. The composition of claim 1, wherein the source of ionizing radiation is thorium.

5. The composition of claim 1 further comprising aluminum.

6. The composition of claim 5, wherein the transition metal is iron, ruthenium, osmium, cobalt, rhodium, iridium, nickel, palladium or platinum.

7. The composition of claim 5, wherein the high electron mobility component is C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃ or Te.

8. The composition of claim 5, wherein the source of ionizing radiation is thorium.

9. The composition of claim 1 further comprising at least one group 1A alkali metal.

10. The composition of claim 9, wherein the group 1A alkali metal is lithium, sodium, or potassium.

11. The composition of claim 1 further comprising aluminum and at least one group 1A alkali metal.

12. The composition of claim 11, wherein the group 1A alkali metal and the aluminum are provided in a mole ratio in a range of about 10:1 to about 1:10 moles of alkali metal to moles of aluminum.

13. The composition of claim 11, wherein the transition metal is iron, ruthenium, osmium, cobalt, rhodium, iridium, nickel, palladium or platinum.

14. The composition of claim 11, wherein the group 1A alkali metal is lithium, sodium, or potassium.

15. The composition of claim 11, wherein the high electron mobility component is C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃ or Te.

16. The composition of claim 11, wherein the source of ionizing radiation is thorium.

17. The composition of claim 11, wherein the transition metal is nickel, the Group 1A alkali metal is lithium, sodium or potassium, the high electron mobility component is germanium, and the source of ionizing radiation is thorium.

18. A method of producing hydrogen gas comprising the steps of:
providing the composition of claim 1; and
contacting the composition with water.

19. A method of producing hydrogen gas comprising the steps of:
providing the composition of claim 5; and
contacting the composition with water.

20. A method of producing hydrogen gas comprising the steps of:
providing the composition of claim 9; and
contacting the composition with water.

21. A method of producing hydrogen gas comprising the steps of:
providing the composition of claim 5; and
contacting the composition with aqueous hydroxide ion.

22. A method of producing hydrogen gas comprising the steps of:
providing the composition of claim 11; and
contacting the composition with water.

23. A method of manufacturing the composition of claim 1, comprising the steps of:
providing the at least one transition metal, the at least one high electron mobility component, and the source of ionizing radiation as ingredients;
melting the ingredients to form a mixture; and
cooling the mixture until the mixture solidifies.

24. A method of claim 23 further comprising exposing the mixture to the source of ionizing radiation.

25. A method of manufacturing the composition of claim 5, comprising the steps of:
providing the at least one transition metal, the aluminum, the at least one high electron mobility component, and the source of ionizing radiation as ingredients;
melting the ingredients to form a mixture; and
cooling the mixture until the mixture solidifies.

26. A method of manufacturing the composition of claim 9, comprising the steps of:
providing the at least one transition metal, the at least one group 1A alkali metal, the at least one high electron mobility component, and the source of ionizing radiation as ingredients;
melting the ingredients to form a mixture; and
cooling the mixture until the mixture solidifies.

27. The method of claim 25, further comprising exposing the mixture to the source of ionizing radiation.

28. The method of claim 26, further comprising exposing the mixture to the source of ionizing radiation.

29. A method of manufacturing the composition of claim 11, comprising the steps of:
providing the at least one transition metal, the aluminum, the at least one group 1A alkali metal, the at least one high electron mobility component; and the source of ionizing radiation as ingredients;
melting the ingredients to form a mixture; and
cooling the mixture until the mixture solidifies.

30. The method of claim 29, further comprising exposing the mixture to the source of ionizing radiation.

31. A battery comprising an anode, a cathode, and an electrolyte, wherein the anode comprises the composition of claim 1.

32. A battery comprising an anode, a cathode, and an electrolyte, wherein the anode comprises the composition of claim 5.

33. A battery comprising an anode, a cathode, and an electrolyte, wherein the anode comprises the composition of claim 9.

34. A battery comprising an anode, a cathode, and an electrolyte, wherein the anode comprises the composition of claim 11.

35. A capacitor comprising an anode in contact with a sample of carbon foam, a cathode, an electrolyte, and a dielectric, wherein the anode comprises the composition of claim 1.

36. A capacitor comprising an anode in contact with a sample of carbon foam, a cathode, an electrolyte, and a dielectric, wherein the anode comprises the composition of claim 5.

37. A capacitor comprising an anode in contact with a sample of carbon foam, a cathode, an electrolyte, and a dielectric, wherein the anode comprises the composition of claim 9.

38. A capacitor comprising an anode in contact with a sample of carbon foam, a cathode, an electrolyte, and a dielectric, wherein the anode comprises the composition of claim 11.

39. A fuel cell comprising an anode, a cathode, and an electrolyte, wherein the anode comprises the composition of claim 1.

40. A fuel cell comprising an anode, a cathode, and an electrolyte, wherein the anode comprises the composition of claim 5.

41. A fuel cell comprising an anode, a cathode, and an electrolyte, wherein the anode comprises the composition of claim 9.

42. A fuel cell comprising an anode, a cathode, and an electrolyte, wherein the anode comprises the composition of claim 11.

43. A fuel cell assembly comprising a conventional hydrogen fuel cell and a hydrogen generator, wherein the hydrogen generator comprises the composition of claim 1 and water.

44. A fuel cell assembly comprising a conventional hydrogen fuel cell and a hydrogen generator, wherein the hydrogen generator comprises the composition of claim 5 and water.

45. A fuel cell assembly comprising a conventional hydrogen fuel cell and a hydrogen generator, wherein the hydrogen generator comprises the composition of claim 9 and water.

46. A fuel cell assembly comprising a conventional hydrogen fuel cell and a hydrogen generator, wherein the hydrogen generator comprises the composition of claim 5 and aqueous hydroxide ion.

47. A fuel cell assembly comprising a conventional hydrogen fuel cell and a hydrogen generator, wherein the hydrogen generator comprises the composition of claim 11 and water.
